(19) United States
(12) Patent Application Publication
(10) Pub. No.: US 2007/0254581 A1
(43) Pub. Date: Nov. 1, 2007

(54) Wild Game Hoist Apparatus and Method

(75) Inventor: John S. Hoffmann, McAllen, TX (US)

Correspondence Address: LUNDEEN & DICKINSON, LLP, PO BOX 131144, HOUSTON, TX, 77219-1144, US

(73) Assignee: ANY INVESTMENTS, INC., McAllen, TX (US)

(21) Appl. No.: 11/306,260

(22) Filed: Dec. 21, 2005

(51) Int. Cl. A22B 7/00

(52) U.S. Cl. 452/187

(57) ABSTRACT

The present invention includes a portable apparatus and method to use the same to field-dress a downed wild game carcass in a remote area not easily accessible by larger vehicles. The apparatus includes a hanging frame pivotable with respect to a base assembly that the carcass can be secured to and raised to allow a hunter to dress the downed game.

### BACKGROUND OF THE INVENTION

The present invention generally relates to an apparatus and method to raise and suspend downed wild game for inspection, dressing, display, or other preparation tasks. More particularly, the present invention relates to a portable apparatus to quickly and easily raise, suspend, and load downed wild game in the field.

Hunters of wild game often travel deep into wooded areas in locations that are often too remote to be reached by conventional automobiles. When dressing downed game, it is preferable to raise the carcass off the ground and work from the top down. Because it is generally desirable to dress the fallen game as soon as possible, various portable dressing stands have been introduced. Most dressing stands of the prior art generally include rigid frames from which a hook assembly suspends the carcass to be dressed. A winch mechanism is mounted to the frame and is used to lift and raise the carcass to the desired height from its position on the ground. Because of the structural rigidity required and the need for a winch mechanism, prior art dressing stands are frequently relatively substantial pieces of equipment and are therefore not easily portable.

In order to preserve the quality of the meat from the downed carcass, hunters must often dress the carcass as soon after making the kill as possible. Therefore, dressing stand portability is paramount to a hunter seeking to dress his kill quickly as hunting locations are frequently in territories inaccessible to conventional vehicles. Typically, hunters travel through wooded areas on four-wheeled all-terrain vehicles to reach their downed game, and then transport the game on these vehicles to more accessible locations where the dressing can proceed. However, for those hunters seeking to dress their downed game as soon as possible, the ability to carry a portable dressing stand upon their four-wheeled vehicles (or other light duty vehicles) would be highly desirable. Furthermore, since time is of the essence, a portable dressing stand that is capable of being setup quickly with little or no preparation would be highly favored by hunters.

Formerly, U.S. Pat. No. 6,739,964 issued on May 25, 2004 to Gearhart, entitled “Deer Hoist” and U.S. Pat. No 6,705,821 issued on Mar. 16, 2004 to Phillipps, et al., entitled “Collapsible Game Hanger for Pickup Truck,” both patents hereby incorporated by reference herein, addressed these needs for a portable game hanger. However, the Deer Hoist of Gearhart is less than optimal in that it requires the device to be attached to a tree and does not provide for the loading and unloading of the game to and from a vehicle. Additionally, Gearhart's invention requires installation upon a scalable tree having few, if any, branches located proximate to the downed game carcass. A hunter would lose valuable time climbing the tree to set up the device. Furthermore, the hanger of Phillipps, et al. is not optimal because a pickup truck (or other large vehicle having a Class III receiver hitch) must be able to reach the downed carcass in order for it to be suspended. A hunter must first transport the carcass to the nearest point where a truck can be driven before the carcass can be suspended. Valuable minutes are lost while the carcass is carried to a location accessible by the vehicle carrying the Phillipps hanger. The present invention addresses the deficiencies of the prior art.

### SUMMARY OF THE INVENTION

The deficiencies of the prior art are addressed by a hanging assembly to unitarily suspend a carcass above a ground surface absent supplemental support. The hanging assembly preferably includes a base assembly positioned upon the ground surface and a hanging frame rotatably connected to the base assembly through a rotation mechanism. The rotation mechanism is preferably configured to allow the hanging frame to pivot between an upright position and a downed position. Preferably, a securing mechanism is configured to secure the hanging frame with respect to the base assembly to prevent rotation therebetween.

The deficiencies of the prior art are also addressed by a method to suspend wild game. The method preferably includes transporting a hanging assembly to a location where the wild game is downed, wherein the hanging assembly includes a hanging frame connected to a base assembly and rotatable about a rotation axis. The method also preferably includes positioning the hanging frame around the downed game and securing the wild game to the hanging frame. The method preferably includes lifting and rotating the hanging frame and the game secured thereto about the rotation axis to achieve an upright position. The method also preferably includes activating a securing mechanism to prevent movement of the hanging frame relative to the base assembly.

### BRIEF DESCRIPTION OF THE DRAWINGS

FIG. 1 is an isometric view drawing of a wild game-dressing stand in an upright position in accordance with a preferred embodiment of the present invention.

FIG. 2 is an isometric view drawing of the wild game-dressing stand of FIG. 1 in a lowered position.

FIG. 3 is an isometric view drawing of an another embodiment of a wild game-dressing stand.

### DETAILED DESCRIPTION OF THE PREFERRED EMBODIMENTS

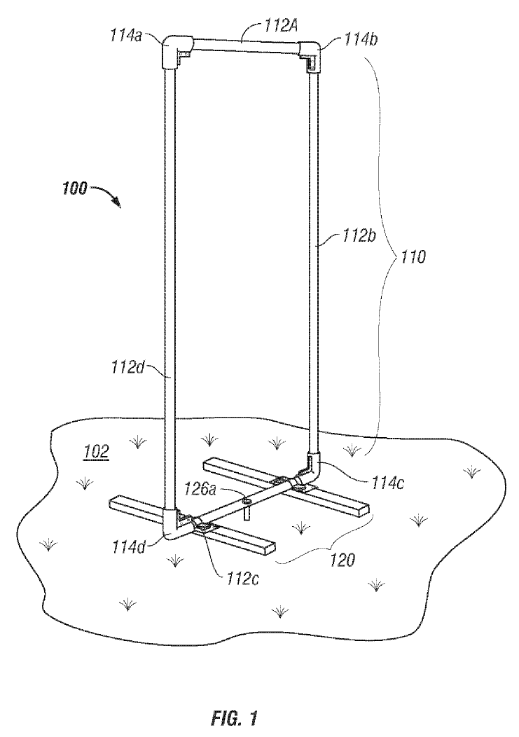

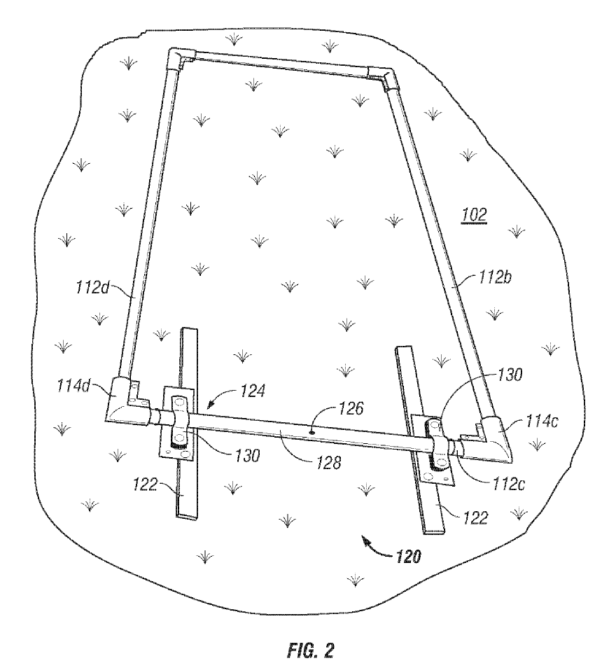

Referring to FIGS. 1 and 2 together, a dressing stand 100 in accordance with one embodiment of the present invention is shown. Dressing stand 100 includes a hanging frame 110 and a base assembly 120. Hanging frame 110 is shown as a tubular structure manufactured from straight tubing sections 112A, 112B, 112C, 112D and corner unions 114A, 114B, 114C, and 114D. Hanging frame 110 is ideally constructed such that tubular structure is of sufficient strength and rigidity to suspend the weight of a carcass with minimal or no deflection in tubing sections 112. Furthermore, tubular structure of hanging frame 110 is desirably constructed such that the weight of hanging frame 110 is minimized. Therefore, thin-walled pieces of steel or aluminum tubing are well suited for pipe sections 112 so long as the tubing is rigid enough to support a downed carcass. Optionally, hanging frame 110 can be constructed as a single piece of bent pipe or tubing such that corner unions 114 are not necessary. Optionally, hooks (not shown) can be suspended from or integrated into top tubing section 112A to suspend the downed animal carcass to be dressed. Alternatively, lengths of bundling wire or rope can be used to suspend the carcass from top tubing section 112A. Furthermore, additional hooks or lengths of bundling wire can secure carcass at its lower end to lower tubing section 112C. Optionally still, since top tubing section 112A is to carry the largest load, it may be constructed from a thicker-walled tubing than remaining sections 112B, 112C, and 112D.

Base assembly 120 is located adjacent to lower tubing section 112C and is configured to allow hanging frame 110 to pivot between an upright (FIG. 1) position and a lowered (FIG. 2) position. Base assembly 120 preferably includes a pair of stabilization legs 122, a rotation mechanism 124, and a securing mechanism 126 to lock dressing stand 100 in the upright position. Stabilization legs 122 are preferably simple in construction and define a base for dressing stand 100 that is suitable to prevent dressing stand 100 from tipping over when a carcass is mounted and the hanging frame 110 is in the upright position. Stabilization legs 122 are shown in FIG. 2 as a pair of angle-iron segments of approximately equal length oriented 90° from the axis of lower tubing section 112C in a plane including the ground 102, but can be constructed of various rigid relatively heavy structural member known to one skilled in the art. The purpose of stabilization legs 122 is to provide an anchor point for dressing stand 100 and to define an area of stabilization whereby the carcass mounted to hanging frame 110 will not tip over unless the center of mass thereof is displaced from within the area of stabilization.

Rotation mechanism 124 provides a rotational axis about which lower tube 112C of hanging frame 110 can rotate to displace hanging frame 110 from lowered position to upright position and back again to the lowered position. Rotation mechanism 124 is shown constructed as a tubing journal 128 spanning between stabilization legs 122 and secured by two pipe straps 130. Ideally, tubing journal 128 of rotation mechanism 124 is constructed as a length of tubing having an inner diameter slightly larger than an outer diameter of lower tubing 112C. Therefore, the interface between lower tubing 112C and tubing journal 128 acts as a journal bearing between the two members. Pipe straps 130 secure tubing journal 128 to base assembly 120 and prevent tubing journal from rotating with respect to base assembly 120.

Finally, securing mechanism 126a, inserted through tubing journal 128 through bore 126 (as shown in FIG. 1) prevents hanging frame 110 from rotating with respect to base assembly 120 when engaged. To ensure that hanging frame 110 remains in upright position relative to base assembly 120, securing mechanism engages hanging frame 110 through tubing journal 128 and prevents further rotation therebetween. Securing mechanism is shown as a pin-type system whereby a bore 126 through tubing journal 128 allows a pin 126a in FIG. 2 to engage a bore (not visible) in lower tubing 112C of hanging frame 110, but any type or configuration of securing mechanism known to one skilled in the art can be used. For example, a similar set of pins could be inserted through straps 130 and further through stabilization legs 122 to prevent movement of the frame when pinned in the upright position. Using the pin configuration as shown in FIGS. 1 and 2, hanging frame 110 is raised to the upright position and the operator engages the pin through the bore 126 of tubing journal 128 and lower tubing 112C. With pin engaged through tubing journal 128 and lower tubing 112C simultaneously, the hanging frame 110 is fixed in the upright position. The strength of the material of the pin resists further rotation of hanging frame 110 relative to base assembly 120 until the pin is removed.

Alternatively, a spring-loaded pin assembly can be located at bore 126 so that the pin automatically engages tubing journal 128 and lower tubing 112C automatically when the upright position is reached. When the operator chooses to release dressing assembly 100 from the upright position, he or she lifts the spring-loaded pin from bore 126 and displaces hanging frame 110 from the upright position. Similar arrangments could be set at each stabilization leg 122 to perform in a similar manner. Furthermore, other modes and configurations for dressing stand 100 can be used without departing from the present invention. Particularly, other polygonal shapes for hanging frame 110 can be used for various types and sizes of game to be suspended therefrom. For instance, a trapezoidal shape can be employed in place of upper tube 112A to allow more options for mounting the downed animal carcass. Additionally, hanging frame 110 can be constructed as a single piece of bent tubing, thereby eliminating the need for corner unions 114.

Alternatively still, base assembly 120 can be constructed such that rotation mechanism 124 is constructed with a solid steel or aluminum rod instead of tubing journal 128. Solid rod (not shown) could replace lower tubing 112C and tubing journal 128 and would preferably be integrated into hanging frame between corner unions 114C and 114D. Pillow blocks (not shown) could replace pipe straps 130, thereby providing a pair of axially aligned journal bearings. Securing mechanisms could be incorporated into each pillow block such that a pin (preferably spring-loaded) would engage the solid rod through the bearings of the pillow blocks. The potential benefit to the solid rod approach would be that additional weight would be added to base assembly 120, thereby acting to lower the center of gravity of dressing assembly 100 and reducing the likelihood of hanging assembly 110 tipping over when a carcass is suspended therefrom.

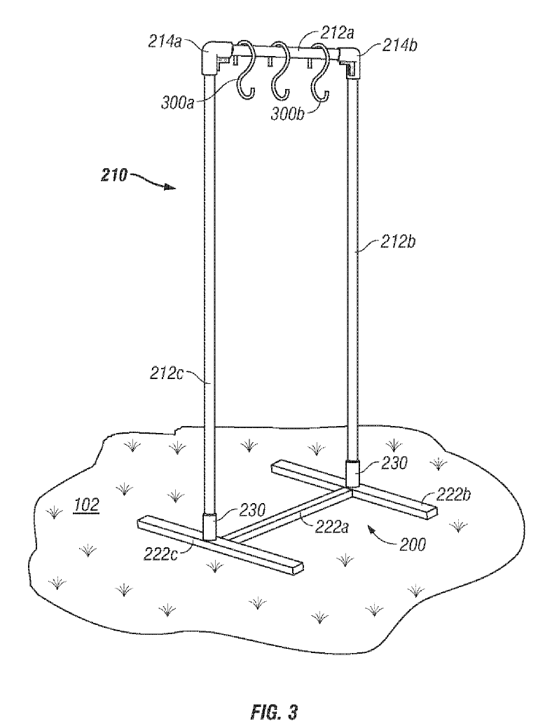

As another embodiment, FIG. 3 discloses a removable base assembly having stabilization legs 222b and 222c, affixed to cross bar 222a providing a stable platform. Each stabilization leg 222b and 222c provides an upwardly extending open receptacle 230 providing a inner diameter slightly larger than the outer diameter of tubing extensions 212b and 212c supporting cross tubing 212a. Thus, when deployed for dressing wild game, this embodiment of the stand allows the base of stand 200 to be placed on the ground 102 and the connected tubing legs 222b and 222c inserted into the base receptacles 230. Cross tubing 212a is joined to legs 222b and 222c at joints 214a and 214b in the manner of the prior embodiment. Cross tubing 212a can provide hooks 300a and 300b for suspending the carcass of the animal to be dressed, in a manner well known to those familiar with the hunting sports.

A benefit of the tubing design of either embodiment shown herein is the limitation of the weight of dressing assembly 100 or 200 to be carried by the hunter to the location of the downed game. Because hunters prefer to dress their downed game as soon as possible to reduce any undesirable effects on the flavor of the meat, dressing assembly 100 must be as light and portable as possible. Through the use of tubular members for hanging frame 110 or 210, hunters are more easily able to carry dressing stand 100 or 200 without assistance deep into wooded areas where their hunting takes place. Such lightweight tubular members can include metal tubing (steel, aluminum, copper, etc.) as well as various plastic pipe materials. As a lightweight assembly, both dressing assemblies 100 and 200 are easily carried by a lone hunter through most wooded areas with little difficulty. Once located at the downed carcass, the hunter can easily raise and dress the carcass with minimal, if any, assistance in a manner that is quick simple, and does not require any additional equipment or winches.

Still referring to FIGS. 1, 2 and 3, the use of dressing assembly 100 in the field to suspend, dress, and transport a downed wild game carcass will now be described. When a hunter has made a kill, dressing assembly 100 is carried to the site of the downed animal. While hanging frame 110 is in the lowered position relative to base assembly 120, dressing assembly is placed around the downed game such that hanging frame 110 completely surrounds the carcass. In this position, the carcass is secured to the upper and lower tubing sections 112A, 112C through the use of wire, rope, tie-wraps, hooks, or any other securing means available to those skilled in dressing wild game.

With the carcass secured to the hanging frame, the hunter grabs upper tubing section 112A and lifts and rotates hanging frame 110 about the axis formed between hanging frame 110 and base assembly 120. As hanging frame 110 is lifted, base assembly 120 remains positioned on ground 102 until hanging frame 110 is substantially perpendicular to base assembly 120 and ground 102. With hanging frame 110 substantially perpendicular to base assembly 120, securing mechanism 126a is engaged to retain hanging frame 110 in upright position. Dressing assembly 100 is capable of unitarily suspending a downed carcass from an elevated height without the need for any supplemental support devices. No winches, boom arms, or other devices are necessary, the dressing assembly alone suspends the carcass. Once in upright position, the hunter is able to completely dress, or otherwise process the downed game carcass.

Once the dressing operation is finished, the hunter can disengage securing mechanism 126a and return carcass to the lowered position. With the dressed wild game carcass in lowered position, the hunter, with the assistance of another person, can carry the secured game carcass horizontally to another location or to be loaded into another vehicle. Alternatively, with the dressed carcass in the upright position, the hunter can position a vehicle adjacent to the hanging assembly 100. With the vehicle's load-carrying surface adjacent to the upright carcass, the hunter can disengage the securing mechanism and slowly lower the carcass onto the adjacent vehicle without assistance. Once partially on the vehicle, the hunter can raise lower tube 112C of the hanging frame to lift and slide hanging assembly 100 (with secured carcass) onto the load-carrying bed to complete the loading operation. The use of the alternate embodiment proceeds in the same manner. Assembly 210 can be placed adjacent the carcass prior to lift and the hind quarters attached to the upper cross tubing 212a by hooks 300a and 300b, for example. Each support leg 212b and 212c can then be inserted in base receptacle 230, then the entire assembly lifted to stand the carcass and frame upright on the ground 102 to commence the dressing of the carcass.

While the invention has been described with respect to a limited number of embodiments, those skilled in the art will appreciate numerous modifications and variations therefrom. It is intended that the appended claims cover all such modifications and variations as fall within the true spirit and scope of the invention.

What is claimed is:

1. A hanging assembly to unitarily suspend a carcass above a ground surface absent supplemental support, the hanging assembly comprising:
a base assembly positioned upon the ground surface
a hanging frame rotatably connected to said base assembly through a rotation mechanism;
said rotation mechanism configured to allow said hanging frame to pivot between an upright position and a downed position; and
a securing mechanism configured to secure said hanging frame with respect to said base assembly and to prevent rotation therebetween.

2. The hanging assembly of claim 1 wherein said hanging frame is constructed from tubing.

3. The hanging assembly of claim 2 wherein said tubing is selected from the group consisting of steel tubing, aluminum tubing, and plastic pipe.

4. The hanging assembly of claim 2 wherein the hanging frame includes corner unions.

5. The hanging assembly of claim 2 wherein the hanging frame is constructed from a single piece of bent tubing.

6. The hanging assembly of claim 1 wherein the hanging frame is constructed in a rectangular geometry.

7. The hanging assembly of claim 1 wherein the hanging frame is constructed in a polygonal geometry.

8. The hanging assembly of claim 1 wherein the hanging frame includes solid bar.

9. The hanging assembly of claim 1 wherein the base assembly includes stabilization legs.

10. The hanging assembly of claim 1 wherein said rotation mechanism includes a tubing journal.

11. The hanging assembly of claim 1 wherein the securing mechanism is a pin.

12. The hanging assembly of claim 11 wherein said pin is a spring-loaded pin.

13. The hanging assembly of claim 1 wherein said rotation mechanism includes a solid bar.

14. The hanging assembly of claim 1 wherein said rotation mechanism includes pillow blocks.

15. A hanging assembly to unitarily suspend a carcass above a ground surface absent supplemental support, the hanging assembly comprising:
a base assembly positioned upon the ground surface
a hanging frame having a cross tubing connected to two legs, each insertably connected to said base assembly; and,
a plurality of hooks suspended from the hanging frame to retain the carcass between said support legs.

16. A method to suspend and dress wild game comprising:
transporting a hanging assembly to a location where the wild game is downed, the hanging assembly including a hanging frame connected to a base assembly and rotatable about a rotation axis;
positioning the hanging frame around the downed game;
securing the wild game to the hanging frame;
lifting and rotating the hanging frame and secured game about the rotation axis to achieve an upright position; and
activating a securing mechanism to prevent movement of the hanging frame relative to the base assembly.

17. The method of claim 16 further including dressing the carcass while secured in the hanging frame in the upright position.

18. The method of claim 16 further including loading the carcass onto a vehicle while still secured within the hanging frame of the hanging assembly.

19. The method of claim 17 further including releasing the securing mechanism to lower the hanging frame and carcass secured thereto following dressing.

20. A method to suspend and dress wild game using the hanging assembly of claim comprising:
transporting a hanging assembly to a location where the wild game is downed, the hanging assembly including a hanging frame providing two support legs and a base assembly providing a receptacle for each support leg;
positioning the hanging frame around the downed game;
securing the wild game to the hanging frame;
tipping the base assembly to a substantially perpendicular plane to the ground engaging each support leg in a receptacle of the base assembly; and,
lifting the hanging frame and secured game axis to achieve an upright position.
